(19) United States
(12) Patent Application Publication
(10) Pub. No.: US 2026/0230865 A1
(43) Pub. Date: Aug. 6, 2026

(54) MEASURING CROSS-LINK INTERFERENCE

(71) Applicant: QUALCOMM Incorporated, San Diego, CA (US)

(72) Inventors: Yuwei REN, Beijing (CN); Mostafa KHOSHNEVISAN, San Diego, CA (US); Jing LEI, San Diego, CA (US); Huilin XU, Beijing (CN)

(21) Appl. No.: 19/151,422

(22) PCT Filed: Mar. 24, 2023
(86) PCT No.: PCT/CN2023/083608

§ 371 Date: Jul. 28, 2025

(51) Int. Cl. H04W 24/08

(52) U.S. Cl. CPC H04W 24/08

(57) ABSTRACT

Various aspects of the present disclosure generally relate to wireless communication. In some aspects, a user equipment (UE) may receive cross-link interference associated with a transmission by another UE, at least one of the UE or the other UE being configured with a plurality of timing advance groups associated, respectively, with a plurality of timing advance values. The UE may select a timing advance value of the plurality of timing advance values. The UE may measure the cross-link interference using the selected timing advance value. Numerous other aspects are described.

### FIELD OF THE DISCLOSURE

Aspects of the present disclosure generally relate to wireless communication and to techniques and apparatuses for measuring cross-link interference.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving cross-link interference associated with a transmission by another UE, at least one of the UE or the other UE being configured with a plurality of timing advance groups associated, respectively, with a plurality of timing advance values. The method may include selecting a timing advance value of the plurality of timing advance values. The method may include measuring the cross-link interference using the selected timing advance value.

Some aspects described herein relate to a method of wireless communication performed by a network node. The method may include transmitting a cross-link interference measurement resource configuration that includes one or more cross-link interference measurement resources. The method may include receiving a transmission that is based at least in part on a cross-link interference measurement, the cross-link interference measurement being associated with a cross-link interference measurement resource of the one or more cross-link interference measurement resources and being based at least in part on a timing advance value of a plurality of timing advance values associated, respectively, with a plurality of timing advance groups.

Some aspects described herein relate to an apparatus for wireless communication at a UE. The apparatus may include a memory and one or more processors coupled to the memory. The one or more processors may be configured to receive cross-link interference associated with a transmission by another UE, at least one of the UE or the other UE being configured with a plurality of timing advance groups associated, respectively, with a plurality of timing advance values. The one or more processors may be configured to select a timing advance value of the plurality of timing advance values. The one or more processors may be configured to measure the cross-link interference using the selected timing advance value.

Some aspects described herein relate to an apparatus for wireless communication at a network node. The apparatus may include a memory and one or more processors coupled to the memory. The one or more processors may be configured to transmit a cross-link interference measurement resource configuration that includes one or more cross-link interference measurement resources. The one or more processors may be configured to receive a transmission that is based at least in part on a cross-link interference measurement, the cross-link interference measurement being associated with a cross-link interference measurement resource of the one or more cross-link interference measurement resources and being based at least in part on a timing advance value of a plurality of timing advance values associated, respectively, with a plurality of timing advance groups.

Some aspects described herein relate to a non-transitory computer-readable medium that stores a set of instructions for wireless communication by a UE. The set of instructions, when executed by one or more processors of the UE, may cause the UE to receive cross-link interference associated with a transmission by another UE, at least one of the UE or the other UE being configured with a plurality of timing advance groups associated, respectively, with a plurality of timing advance values. The set of instructions, when executed by one or more processors of the UE, may cause the UE to select a timing advance value of the plurality of timing advance values. The set of instructions, when executed by one or more processors of the UE, may cause the UE to measure the cross-link interference using the selected timing advance value.

Some aspects described herein relate to a non-transitory computer-readable medium that stores a set of instructions for wireless communication by a network node. The set of instructions, when executed by one or more processors of the network node, may cause the network node to transmit a cross-link interference measurement resource configuration that includes one or more cross-link interference measurement resources. The set of instructions, when executed by one or more processors of the network node, may cause the network node to receive a transmission that is based at least in part on a cross-link interference measurement, the cross-link interference measurement being associated with a cross-link interference measurement resource of the one or more cross-link interference measurement resources and being based at least in part on a timing advance value of a plurality of timing advance values associated, respectively, with a plurality of timing advance groups.

Some aspects described herein relate to an apparatus for wireless communication. The apparatus may include means for receiving cross-link interference associated with a transmission by another apparatus, at least one of the apparatus or the other apparatus being configured with a plurality of timing advance groups associated, respectively, with a plurality of timing advance values. The apparatus may include means for selecting a timing advance value of the plurality of timing advance values. The apparatus may include means for measuring the cross-link interference using the selected timing advance value.

Some aspects described herein relate to an apparatus for wireless communication. The apparatus may include means for transmitting a cross-link interference measurement resource configuration that includes one or more cross-link interference measurement resources. The apparatus may include means for receiving a transmission that is based at least in part on a cross-link interference measurement, the cross-link interference measurement being associated with a cross-link interference measurement resource of the one or more cross-link interference measurement resources and being based at least in part on a timing advance value of a plurality of timing advance values associated, respectively, with a plurality of timing advance groups.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example logical architecture of a distributed radio access network, in accordance with the present disclosure.

FIG. 5 is a diagram illustrating an example of multi-transmission reception point communication, in accordance with the present disclosure.

FIG. 6 is a diagram illustrating an example of timing advance for downlink and uplink transmissions between a network node and a UE in a wireless network, in accordance with the present disclosure.

FIG. 7 is a diagram illustrating an example of cross-link interference detection and mitigation, in accordance with the present disclosure.

FIG. 8 is a diagram illustrating an example of cross-link interference in multiple timing advance groups, in accordance with the present disclosure.

FIG. 9 is a diagram illustrating an example of measuring cross-link interference, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

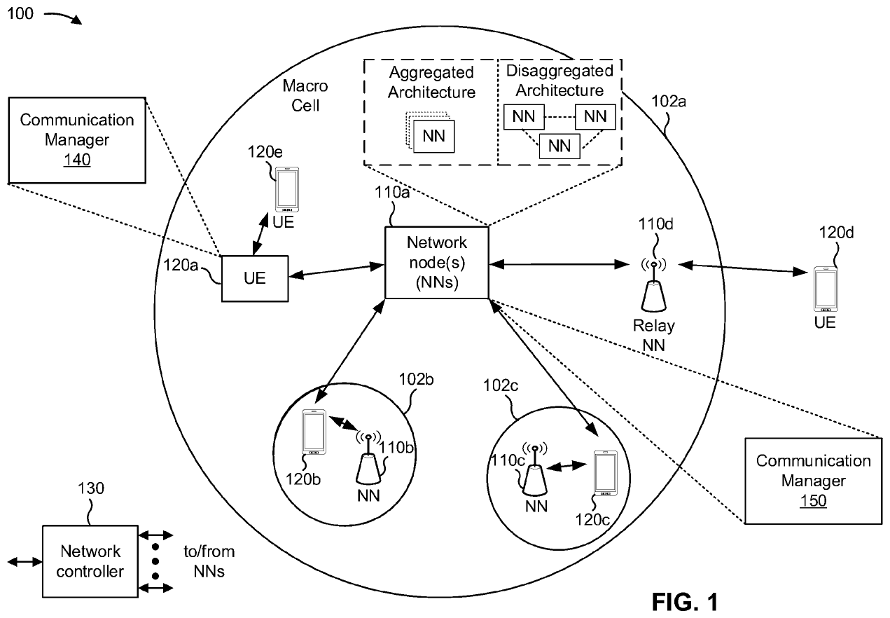

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive cross-link interference associated with a transmission by another UE, at least one of the UE or the other UE being configured with a plurality of timing advance groups associated, respectively, with a plurality of timing advance values; select a timing advance value of the plurality of timing advance values; and measure the cross-link interference using the selected timing advance value. Additionally, or alternatively, the communication manager 140 may perform one or more other operations described herein.

In some aspects, the network node 110 may include a communication manager 150. As described in more detail elsewhere herein, the communication manager 150 may transmit a cross-link interference measurement resource configuration that includes one or more cross-link interference measurement resources; and receive a transmission that is based at least in part on a cross-link interference measurement, the cross-link interference measurement being associated with a cross-link interference measurement resource of the one or more cross-link interference measurement resources and being based at least in part on a timing advance value of a plurality of timing advance values associated, respectively, with a plurality of timing advance groups. Additionally, or alternatively, the communication manager 150 may perform one or more other operations described herein.

As indicated above, FIG. 1 is provided as an example. Other examples may differ from what is described with regard to FIG. 1.

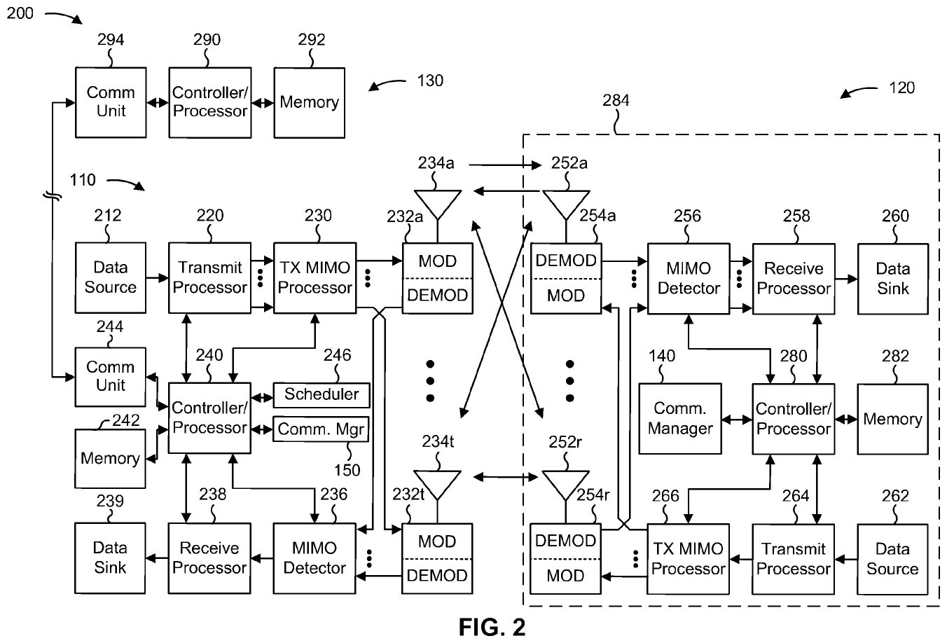

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

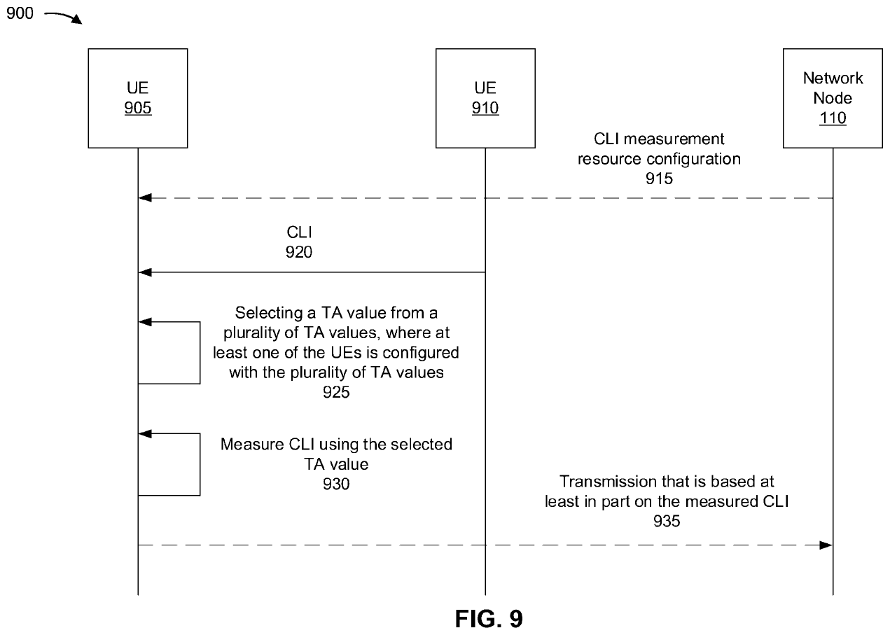

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 9-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 9-13).

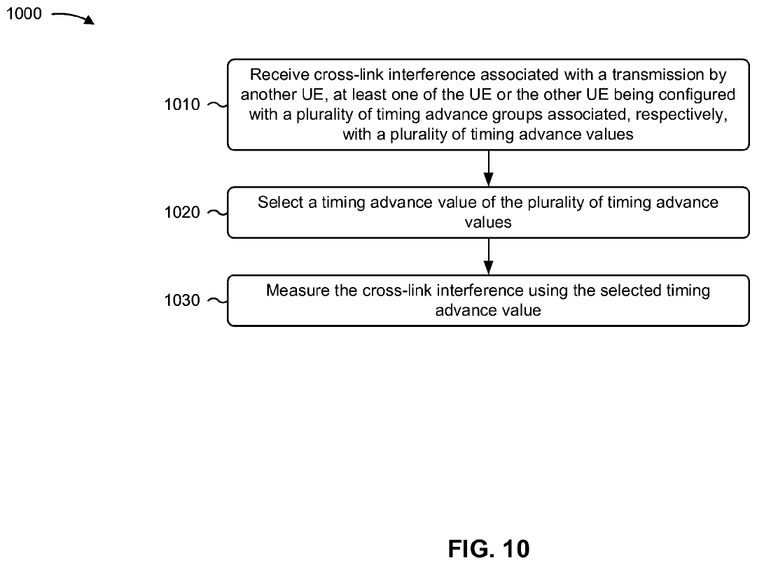

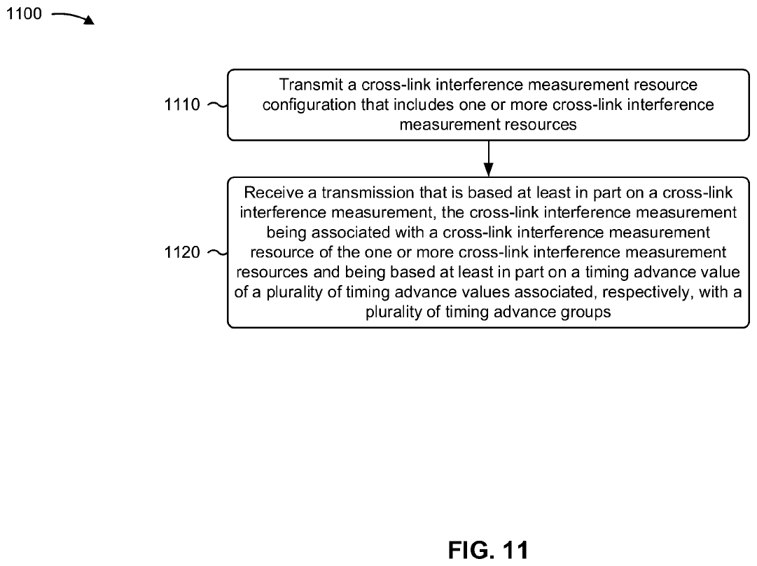

The controller/processor 240 of the network node 110, the controller/processor 280 of the UE 120, and/or any other component(s) of FIG. 2 may perform one or more techniques associated with cross-link interference measurement, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, UE 120 includes means for receiving cross-link interference associated with a transmission by another UE, at least one of the UE or the other UE being configured with a plurality of timing advance groups associated, respectively, with a plurality of timing advance values; means for selecting a timing advance value of the plurality of timing advance values; and/or means for measuring the cross-link interference using the selected timing advance value. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a cross-link interference measurement resource configuration that includes one or more cross-link interference measurement resources; and/or means for receiving a transmission that is based at least in part on a cross-link interference measurement, the cross-link interference measurement being associated with a cross-link interference measurement resource of the one or more cross-link interference measurement resources and being based at least in part on a timing advance value of a plurality of timing advance values associated, respectively, with a plurality of timing advance groups. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

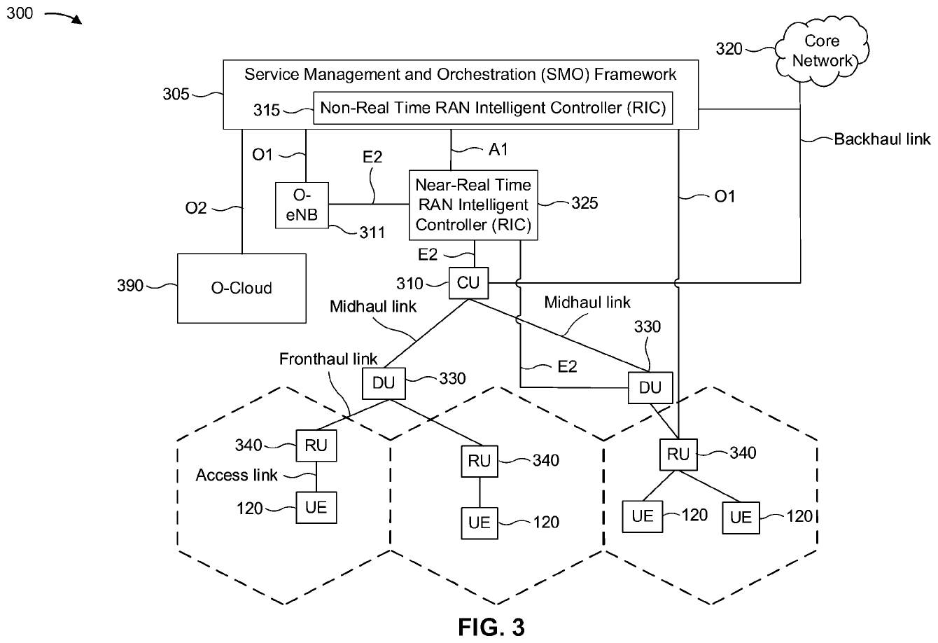

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

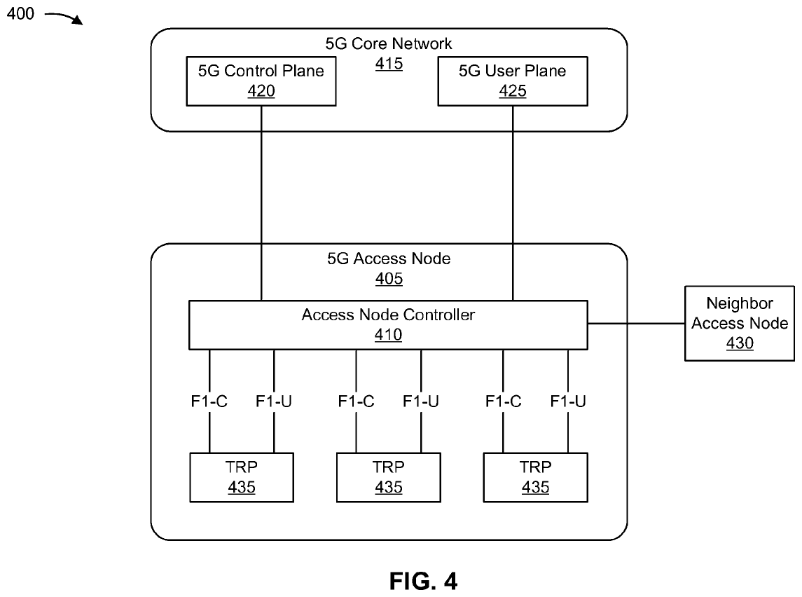

FIG. 4 illustrates an example logical architecture of a distributed radio access network 400, in accordance with the present disclosure.

A 5G access node 405 may include an access node controller 410. The access node controller 410 may be a central unit (CU) of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may include a DU and/or an RU of the distributed RAN 400. In some aspects, a TRP 435 may correspond to a network node 110 described above in connection with FIG. 1. For example, different TRPs 435 may be included in different network nodes 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400, referred to elsewhere herein as a functional split. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

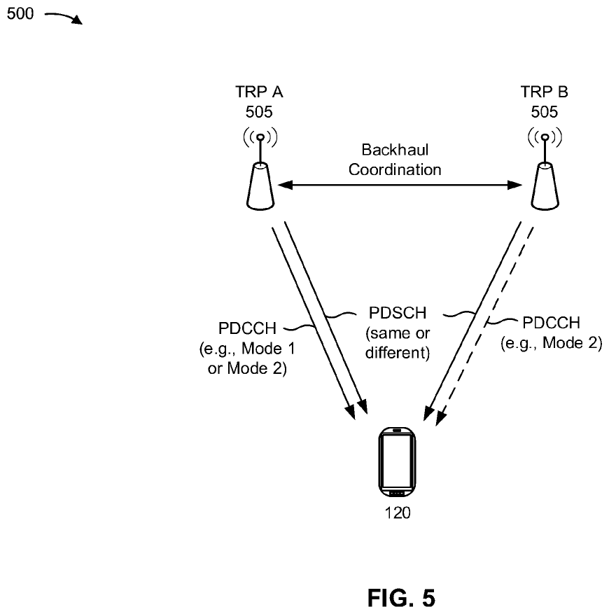

FIG. 5 is a diagram illustrating an example 500 of multi-TRP communication, in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different network nodes 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). This may be referred to as single-DCI (sDCI). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. This may be referred to as multi-DCI (mDCI). In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

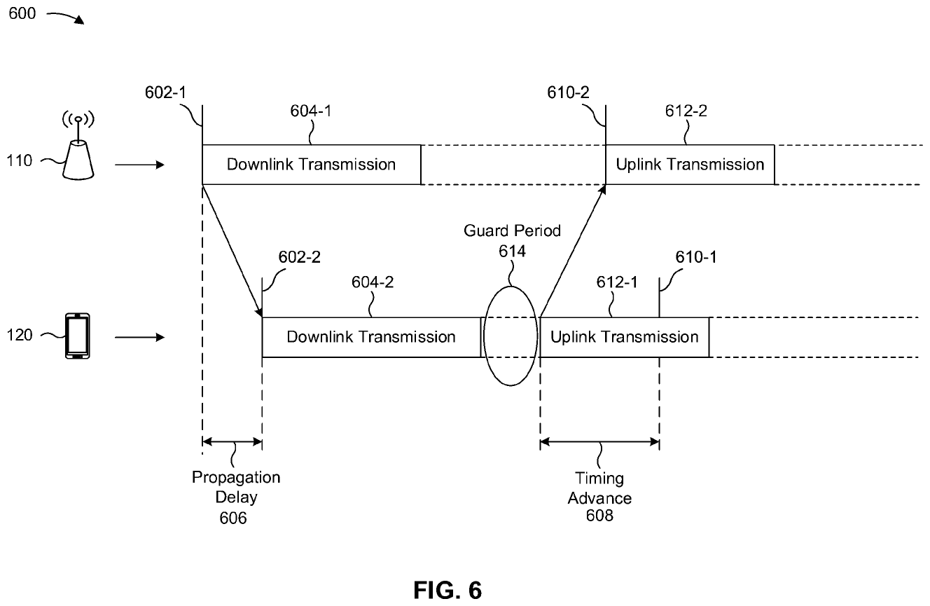

FIG. 6 is a diagram illustrating an example 600 of timing advance for downlink and uplink transmissions between a network node and a UE in a wireless network, in accordance with the present disclosure. In some examples, the downlink and/or uplink transmissions are based at least in part on a timing advance and/or a guard period between communications. As one example, a network node 110 may configure a downlink transmission to end before the start of a guard period. As another example, the UE 120 may advance a start time for an uplink transmission based at least in part on a timing advance.

As shown by reference number 602-1, a network node 110 may begin a downlink transmission 604-1 to a UE 120 at a first point in time. In some examples, the first point in time may be based at least in part on a timing scheme defined by a telecommunication system and/or telecommunication standard. To illustrate, the telecommunication standard may define various time partitions for scheduling transmissions between devices. As one example, the timing scheme may define radio frames (sometimes referred to as frames), where each radio frame has a predetermined duration (e.g., 10 milliseconds (msec)). Each radio frame may be further partitioned into a set of Z (Z≥1) subframes, where each subframe may have a predetermined duration (e.g., 1 msec). Each subframe may be further partitioned into a set of slots and/or each slot may include a set of L symbol periods (e.g., fourteen symbol periods, seven symbol periods, or another number of symbol periods). Thus, the first point in time as shown by the reference number 602-1 may be based at least in part on a time partition as defined by a telecommunication system (e.g., a frame, a subframe, a slot, a mini-slot, and/or a symbol).

In some examples, the network node 110 and the UE 120 may wirelessly communicate with one another (e.g., directly or via one or more network nodes) based at least in part on the defined time partitions. However, each device may have different timing references for the time partitions. To illustrate, and as shown by the reference number 602-1, the network node 110 may begin the downlink transmission 604-1 at a particular point in time that may be associated with a defined time partition based at least in part on a time perspective of the network node 110. For example, the network node 110 may associate the particular point in time with a defined time partition, such as a beginning of a symbol, a beginning of a slot, a beginning of a subframe, and/or a beginning of a frame. However, the downlink transmission may incur a propagation delay 606 in time, such as a time delay based at least in part on the downlink transmission traveling between a network node 110 (e.g., an RU) and the UE 120. As shown by reference number 602-2, the UE 120 may receive downlink transmission 604-2 (corresponding to downlink transmission 604-1 transmitted by the network node 110) at a second point in time that is later in time relative to the first point in time. From a time perspective of the UE 120, however, the UE 120 may associate the second point in physical time shown by the reference number 602-2 with the same particular point in time of the defined time partition as the network node 110 (e.g., a beginning of the same symbol, a beginning of the same mini-slot, a beginning of the same slot, a beginning of the same subframe, and/or a beginning of the same frame). Thus, as shown by the example 600, the time perspective of the UE 120 may be delayed in time from the time perspective of the network node 110.

In wireless communication technologies like 4G/LTE and 5G/NR, a timing advance (TA) value is used to control a timing of uplink transmissions by a UE (e.g., UE 120 and/or the like) such that the uplink transmissions are received by a network node 110 (e.g., an RU) at a time that aligns with an internal timing of the network node 110. A network node 110 may determine the TA value to a UE (e.g., directly or via one or more network nodes) by measuring a time difference between reception of uplink transmissions from the UE and a subframe timing used by the network node 110 (e.g., by determining a difference between when the uplink transmissions were supposed to have been received by the network node 110, according to the subframe timing, and when the uplink transmissions were actually received). The network node 110 may transmit a TA command (TAC) to instruct the UE to transmit future uplink communications earlier or later to reduce or eliminate the time difference and align timing between the UE and network node 110. The TA command is used to offset timing differences between the UE and the network node 110 due to different propagation delays that occur when the UE is different distances from the network node 110. If TA commands were not used, then uplink transmissions from different UEs (e.g., located at different distances from the network node 110) may collide due to mistiming even if the uplink transmissions are scheduled for different subframes.

To illustrate, without adjusting a start time of an uplink transmission, the UE 120 may be configured to begin an uplink transmission at a scheduled point in time based at least in part on the defined time partitions as described elsewhere herein. As shown by reference number 610-1, a start of the scheduled point in time may occur at a third physical point in time based at least in part on the timing perspective of the UE 120. However, and as shown by reference number 610-2, the scheduled point in time with reference to the timing perspective of the network node 110 (e.g., an RU) may occur at a fourth point in physical time that occurs before the third point in physical time as shown by the reference number 610-1. Accordingly, the network node 110 may instruct the UE 120 (e.g., directly or via one or more network nodes) to apply a timing advance 608 to an uplink transmission to better align reception of the uplink transmission with the timing perspective of the network node 110. However, in some examples, the fourth point in time shown by the reference number 610-2 may occur at or near a same physical point in time as the third point in time shown by the reference number 610-1 such that uplink transmissions from the UE 120 to the network node 110 incur the propagation delay 606. In such a scenario, the network node 110 may instruct the UE 120 to apply a timing advance with a time duration corresponding to the propagation delay 606.

As shown by the example 600, the UE 120 may adjust a start time of an uplink transmission 612-1 based at least in part on the timing advance 608 and the start of the scheduled point in time (e.g., at the third physical point in time shown by the reference number 610-1). Based at least in part on propagation delay, the network node 110 may receive an uplink transmission 612-2 (corresponding to the uplink transmission 612-1 transmitted by the UE 120) at the fourth point in physical time shown by the reference number 610-2.

In some examples, a timing advance value may be based at least in part on twice an estimated propagation delay (e.g., the propagation delay 606) and/or may be based at least in part on a round trip time (RTT). A network node 110 (e.g., a DU or a CU) may estimate the propagation delay and/or select a timing advance value based at least in part on communications with the UE 120. As one example, the network node 110 may estimate the propagation delay based at least in part on a network access request message from the UE 120. Additionally, or alternatively, the network node 110 may estimate and/or select the timing advance value from a set of fixed timing advance values.

In some examples, a telecommunication system and/or telecommunication standards may define a guard period 614 (e.g., a time duration) between transmissions to provide a device with sufficient time for switching between different transmission and/or reception modes, for transient settling, to provide a margin for timing misalignment between devices, and/or for propagation delays. In some examples, a guard period is a period during which no transmissions or receptions are scheduled and/or allowed to occur. A guard period may provide a device with sufficient time to reconfigure hardware and/or allow the hardware to settle within a threshold value to enable a subsequent transmission. The guard period 614 may sometimes be referred to as a gap, a switching guard period, or a guard interval.

In some examples, a network node 110 (e.g., a DU or a CU) may select a starting transmission time and/or a transmission time duration based at least in part on a receiving device and/or the guard period. For example, the network node 110 may select an amount of content (e.g., data and/or control information) to transmit in the downlink transmission 604-1 based at least in part on beginning the transmission at the first point in time shown by the reference number 602-1 and/or the UE 120 completing reception of the downlink transmission 604-2 prior to a starting point of the guard period 614. Alternatively, or additionally, the UE 120 may select an amount of content (e.g., data and/or control information) to transmit in the uplink transmission 612-1 based at least in part on the timing advance 608, the third point in time shown by the reference number 610-1, and/or refraining from beginning the uplink transmission 612-1 until the guard period 614 has ended.

As indicated above, FIG. 6 is provided as an example. Other examples may differ from what is described with regard to FIG. 6.

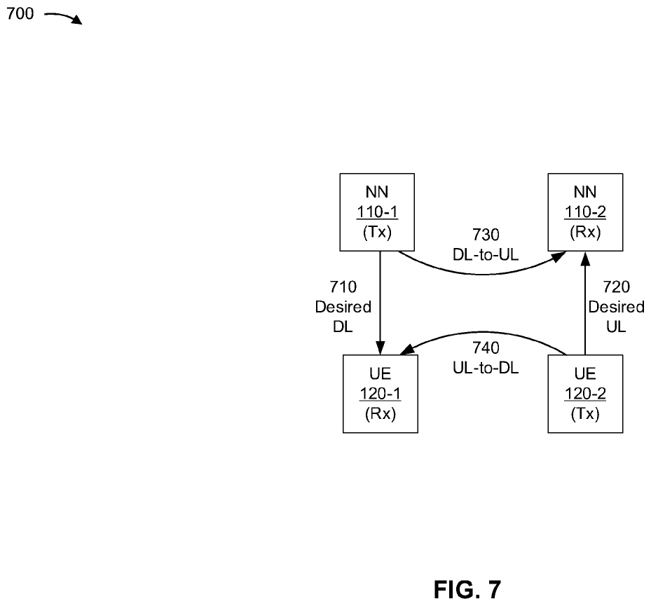

FIG. 7 is a diagram illustrating an example 700 of cross-link interference detection and mitigation, in accordance with the present disclosure.

In dynamic time division duplexing (TDD), the allocation of network resources to uplink and downlink may be dynamically modified depending on a traffic load. For example, a network node 110 may configure a TDD configuration (e.g., a TDD pattern) with more uplink TTIs (e.g., frames, subframes, slots, mini-slots, and/or symbols) for a UE 120 when the UE 120 has uplink data to transmit, and may configure a TDD configuration with more downlink TTIs for the UE 120 when the UE 120 has downlink data to receive. The TDD configuration may be dynamically configured to modify the allocation of uplink TTIs and downlink TTIs used for communication between the network node 110 and the UE 120.

As shown in FIG. 7, when neighboring network nodes 110 use different TDD configurations to communicate with UEs 120, this may result in a downlink communication 710 between a first network node 110-1 and a first UE 120-1 in a same TTI as an uplink communication 720 between a second network node 110-2 and a second UE 120-2. These communications in different transmission directions (e.g., downlink vs. uplink) in the same TTI may interfere with one another, which may be referred to as cross-link interference (CLI).

For example, as shown by reference number 730, the downlink communication 710 transmitted by the first network node 110-1 may be received by the second network node 110-2, and may interfere with reception, by the second network node 110-2, of the uplink communication 720 from the second UE 120-2. This may be referred to as downlink-to-uplink (DL-to-UL) interference, network node to network node interference, or gNB-to-gNB interference.

Further, as shown by reference number 740, the uplink communication 720 transmitted by the second UE 120-2 may be received by the first UE 120-1, and may interfere with reception, by the first UE 120-1, of the downlink communication 710 from the first network node 110-1. This may be referred to as uplink-to-downlink (UL-to-DL) interference or UE-to-UE interference. This UE to UE interference may occur and/or may increase when the first UE 120-1 and the second UE 120-2 are in close proximity, and may be avoided or mitigated by preventing scheduling of the UEs 120 in different transmission directions in the same TTI.

As indicated above, FIG. 7 is provided as an example. Other examples are possible and may differ from what was described with respect to FIG. 7.

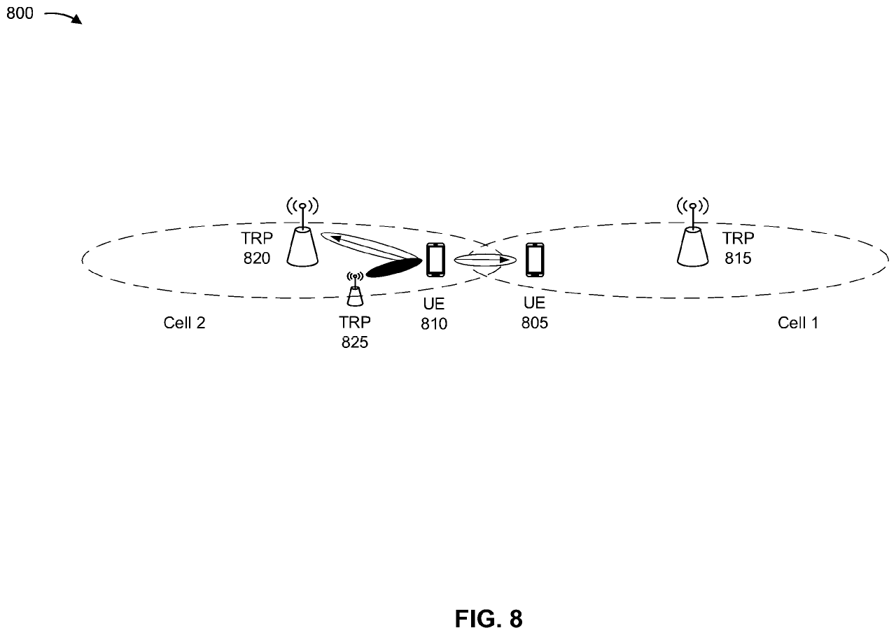

FIG. 8 is a diagram illustrating an example 800 of cross-link interference in multiple timing advance groups, in accordance with the present disclosure. A timing advance group (TAG) may include one or more devices that have the same timing advance values. In some cases, multiple timing advance groups may be configured, for example, for mDCI communications. In some cases, two TAGs may be configured on a same component carrier. This may be applicable to FR1 and FR2 communications, among other examples. The DL reference timing for each TAG may be separately configured. A PDCCH ordered random access channel (RACH) may be supported for the mDCI communications. In some cases, an association between a TAG and target UL channels or signals may be configured. In one example, the TAG may be associated with a TCI state or spatial relation. In another example, the TAG may be associated with a control resource set (CORESET) pool index. In another example, the TAG may be associated with a synchronization signal block (SSB) group. In another example, such as for dynamic grant (DG) or DCI activation, an RRC configured TAG identifier (ID) may be associated with a CORESET pool index for periodic or semi-persistent scheduling (SPS) communications.

As shown in FIG. 8, a UE 805 and a UE 810 may communicate with one or more TRPs. For example, the UE 805 may communicate with a TRP 815, which may be the serving cell for the UE 805, and the UE 810 may communicate with a TRP 820, which may be the serving cell for the UE 810. Additionally, the UE 810 may communicate with a TRP 825, and the UE 805 may communicate with the TRP 820 and/or the TRP 825. In some cases, the UE 810 may be an aggressor UE, and the UE 805 may be a victim UE. The uplink timing for the UE 805 may be the same as the uplink timing for the UE 810, and the CLI timing for the UE 805 may be equal to the UL timing for the UE 805.

In some cases, when a UE measures a sounding reference signal (SRS) RSRP (SRS-RSRP) or a CLI-RSSI, a constant offset relative to the downlink reference timing in a serving cell may be applied. The constant offset value may be based at least in part on UE implementation and may be at least Tc×NTA_offset, where Te is a constant and NTA_offset is a timing advance offset. In some cases, CLI may occur among the adjacent UEs, and therefore, propagation delay may be limited. In some cases, CLI measurement timing may be aligned with an UL transmission timing of an aggressor UE. For intra-cell CLI, the adjacent UE (aggressor UE) may use approximately the same UL timing as the victim UE. Thus, the victim UE may be able to leverage its own UL timing for CLI measurements. For inter-cell CLI, the adjacent UE may use the same UL timing or may use a different UL timing. As shown in FIG. 8, for cell 1 and cell 2, CLI may occur between the UE 805 and the UE 810 which are cell edge UEs. If the two cells have different sizes, the timing advance offset may be based at least in part on a DL timing difference between the SSBs of the two cells.

A victim UE (UE 805) may leverage a serving cell UL timing for performing a CLI measurement associated with CLI from an aggressor UE (UE 810). However, in some cases, at least one of the victim UE or the aggressor UE may be configured with a plurality of TA values, and the victim UE may not be able to determine which TA value is to be used for performing the CLI measurement. In one example, the aggressor UE may be configured with two TA values for UL transmissions in an mTRP scenario. The aggressor UE may perform a first UL transmission to a first TRP (TRP 820) using a first TA value and a second UL transmission to a second TRP (TRP 825) using a second TA value. The victim UE may observe CLI that is based at least in part on one of the transmissions by the aggressor UE. However, the victim UE may not be able to determine which TA value (of the two TA values) is to be used for measuring the CLI. For example, the victim UE may not be able to determine whether to measure the CLI using the first TA value for measuring the CLI, for example, if the CLI is a result of the transmission from the aggressor UE to the first TRP, or to use the second TA value for measuring the CLI, for example, if the CLI is a result of the transmission from the aggressor UE to the second TRP. In another example, the victim UE may be configured with a plurality of TA values. For example, the victim UE may be configured with multiple timing advance groups (mTAG), each timing advance group being associated with a timing advance value. The victim UE may be configured with multiple UL timings for different TRP transmissions. The victim UE may use a first TA value for transmissions to a third TRP (TRP 815) and may use a second TA value for transmissions to the second TRP (TRP 825). However, the victim UE may not be able to determine which TA value is to be used for measuring CLI observed from the aggressor UE. This may result in incorrect CLI measurements, for example, if the wrong TA value is used for performing the CLI measurement.

Techniques and apparatuses are described herein for measuring cross-link interference. A UE (a victim UE) may receive CLI associated with a transmission by another UE (an aggressor UE). At least one of the UE and the other UE may be configured with a plurality of TA groups associated, respectively, with a plurality of TA values. The UE may select a TA value from the plurality of TA values, and may measure the CLI using the selected TA value. In some aspects, a network node may transmit measurement timing information for a configured CLI resource to be used by the UE for performing the CLI measurement. In some aspects, the UE may associate a TAG with a select measurement resource to be used for performing the CLI measurement. The techniques and apparatuses described herein may enable a UE that observes interference from another UE to perform a CLI measurement using a correct TA value when at least one of the UE and the other UE are configured with a plurality of TA values. This may increase a likelihood of correct CLI measurements by the UE.

As indicated above, FIG. 8 is provided as an example. Other examples are possible and may differ from what was described with respect to FIG. 8.

FIG. 9 is a diagram illustrating an example 900 of measuring cross-link interference, in accordance with the present disclosure. A UE 905 may communicate with a UE 910. The UE 905 and the UE 910 may include some or all of the features of the UE 120. The UE 905 and/or the UE 910 may communicate with the network node 110. The UE 905 and/or the UE 910 may be configured with a plurality of TA values. In one example, the UE 905 (victim UE) may be configured with the plurality of TA values. In another example, the UE 910 (aggressor UE) may be configured with the plurality of TA values. In another example, both the UE 905 and the UE 910 may be configured with the plurality of TA values.

As shown by reference number 915, the network node 110 may transmit, and the UE 905 may receive, a CLI resource configuration, such as a CLI measurement resource configuration. The CLI resource configuration may include one or more CLI resources, such as one or more CLI measurement resources to be used for performing CLI measurements.

As shown by reference number 920, the UE 905 may receive CLI. For example, the UE 905 may observe CLI associated with a transmission by the UE 910 to a network node or TRP. As shown by reference number 925, the UE 905 may select a TA value from the plurality of TA values. The UE 905 may select the TA value from the plurality of TA values for performing a CLI measurement associated with the observed CLI. As shown by reference number 930, the UE 905 may measure CLI using the selected TA value. For example, the UE 905 may measure the observed CLI using the selected TA value. Additional details are described below.

In some aspects, the network node 110 may indicate measurement timing information for a configured CLI resource. For example, the network node 110 may transmit the measurement timing information for the configured CLI resource to the UE 905. In one example, after transmitting the CLI resource configuration, the network node 110 may indicate measurement timing information for the configured CLI resource. In this example, the network node 110 may transmit, and the UE 905 may receive, a CLI resource configuration. The network node 110 may transmit, and the UE 905 may receive, a CLI timing configuration for the CLI resource. The UE 905 may perform a CLI measurement based at least in part on the CLI timing configuration. The network node 110 may transmit, and the UE 905 may receive, another CLI timing configuration for the CLI resource, and the UE 905 may perform another CLI measurement based at least in part on the other CLI timing configuration for the CLI resource.

In another example, after transmitting the CLI resource configuration, the network node 110 may configure a set of timing values associated with a plurality of TAGs. The set of timing values may be a set of relative timing values. Additionally, the network node 110 may configure an element index within the set of timing values to indicate the timing value for the CLI measurement. In this example, the network node 110 may transmit, and the UE 905 may receive, a CLI resource configuration. The network node 110 may transmit, and the UE 905 may receive, a timing set configuration for a CLI measurement. The network node 110 may transmit, and the UE 905 may receive, a timing offset indication. The UE 905 may perform a CLI measurement based at least in part on the timing set configuration and the timing offset indication. The network node 110 may transmit, and the UE 905 may receive, another timing offset indication, and the UE 905 may perform a CLI measurement based at least in part on the timing set configuration and the other timing offset indication.

In another example, the CLI resource configuration may include separate timing information for the resource. The timing information may be transmitted, for example, using DCI, a MAC control element (MAC-CE), or RRC signaling. The timing information may include a relative timing value, for example, relative to the serving cell DL timing or serving cell UL timing for a serving cell associated with the UE 905. If mTAG is enabled for the UE 905, the timing offset may be relative to one TAG of the plurality of TAGs. An example of the resource configuration that includes the timing information (MeasTiming) and timing value (Timing-value) is shown below:

| SRS-ResourceConfigCLI-r16 ::= SEQUENCE { | |
|---|---|
| srs-Resource-r16 | SRS-Resource, |
| srs-SCS-r16 | SubcarrierSpacing, |
| refServCellIndex-r16 | ServCellIndex, |
| refBWP-r16 | BWP-id, |
| MeasTiming | Timing-value |

...
}

When the UE 905 (victim UE) is enabled with mTAG, a plurality of UL TA values (e.g., two UL TA values) for serving cell UL transmissions may be associated with different TRPs for the UE 905. Depending on which TAG is used by the UE 910 (aggressor UE) for transmitting an UL signal corresponding to the CLI (e.g., assuming that the UE 910 is configured with at least one TAG of the plurality of TAGs configured in the UE 905), one of the TA values associated with a TAG can be used for the CLI measurement by the UE 905 (e.g., assuming that the reception timing of the CLI resource is the same as the serving cell UL timing for this TAG).

In some aspects, a TAG may be associated with one or more CLI resources. In one example, the TAG may be associated with a TCI state or a spatial relation (e.g., based at least in part on the TAG ID being configured as part of the UL or joint TCI state or spatial relation for the UE 905), and the TCI state or spatial relation may be associated with the CLI resource. In another example, the TAG may be associated with a CORESET pool index for the UE 905, and the CORESET pool index may be associated with the CLI resource. In another example, the TAG may be associated with an SSB group for the UE 905, and the SSB group may be associated with the CLI resource. In these examples, a serving cell UL transmission by a serving cell associated with the UE 905 may use the timing information associated with the TAG but may not use the other information such as the TCI state, the CORESET, or the pathloss reference signal for the CLI measurement. In another example, a TAG ID associated with a TAG may be RRC configured for the CLI resource (e.g., within the CLI resource configuration).

In some aspects, when both the UE 905 and the UE 910 are enabled with mTAG and mTRP, based at least in part on the mTAG information associated with the UE 910, the network node 110 may configure the UE 905 with the corresponding reception timing of the CLI by configuring the association for the same TAG (e.g., the TCI state or SSB group of the TRP associated with the UE 905). In some aspects, the UE 910 may be configured with a single TAG. Cells or TRPs associated with the UE 910 and the UE 905 may coordinate, and the configured TAG for the UE 905 may be based at least in part on a location of (or TA value corresponding to) TRP A and TRP B associated with the UE 905 and TRP C associated with the UE 910. In some other aspects, the UE 910 may be configured with mTAG. Both TRP C and TRP D associated with the UE 910 may be used, and one of the two TAGs may be configured for UL transmissions by the UE 910.

In some aspects, in the CLI measurement, there may be two metrics associated with two CLI resource types, such as the CLI-RSSI resource and the CLI-RSRP resource. RSSI and RSRP may have different measurement constraints.

In some aspects, a UE capability may be defined based at least in part on a CLI reception timing configuration with mTAG. In one example, a single UE capability may be defined for RSSI measurements and/or for RSRP measurements. In another example, separate UE capabilities may be defined for RSSI measurements and RSRP measurements. For example, the timing configuration related to the mTAG may only be effective for the CLI-RSSI resource, the CLI-RSRP resource, or for both the CLI-RSSI resource and the CLI-RSRP resource. RSRP may be able to provide more accurate interference measurement, and it may be necessary to set accurate TA in mTAG. Thus, to reduce complexity, it may be sufficient to enable the RSRP reception timing configuration in mTAG.

As shown by reference number 935, the UE 905 may transmit, and the network node 110 may receive, a transmission that is based at least in part on the CLI measurement. For example, the transmission may be based at least in part on timing information associated with the CLI measurement.

As indicated above, FIG. 9 is provided as an example. Other examples are possible and may differ from what was described with respect to FIG. 9.

FIG. 10 is a diagram illustrating an example process 1000 performed, for example, by a UE, in accordance with the present disclosure. Example process 1000 is an example where the UE (e.g., UE 120) performs operations associated with measuring cross-link interference.

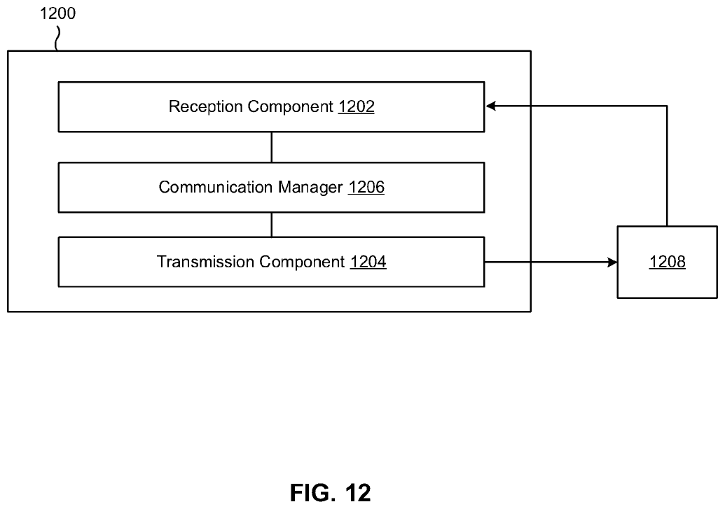

As shown in FIG. 10, in some aspects, process 1000 may include receiving cross-link interference associated with a transmission by another UE, at least one of the UE or the other UE being configured with a plurality of timing advance groups associated, respectively, with a plurality of timing advance values (block 1010). For example, the UE (e.g., using reception component 1202 and/or communication manager 1206, depicted in FIG. 12) may receive cross-link interference associated with a transmission by another UE, at least one of the UE or the other UE being configured with a plurality of timing advance groups associated, respectively, with a plurality of timing advance values, as described above.

As further shown in FIG. 10, in some aspects, process 1000 may include selecting a timing advance value of the plurality of timing advance values (block 1020). For example, the UE (e.g., using communication manager 1206, depicted in FIG. 12) may select a timing advance value of the plurality of timing advance values, as described above.

As further shown in FIG. 10, in some aspects, process 1000 may include measuring the cross-link interference using the selected timing advance value (block 1030). For example, the UE (e.g., using communication manager 1206, depicted in FIG. 12) may measure the cross-link interference using the selected timing advance value, as described above.

Process 1000 may include additional aspects, such as any single aspect or any combination of aspects described below and/or in connection with one or more other processes described elsewhere herein.

In a first aspect, process 1000 includes receiving, from a network node, a cross-link interference measurement resource configuration that includes an indication of a cross-link interference measurement resource, and receiving, from the network node, after receiving the cross-link interference measurement resource configuration, an indication of a timing advance value to be used for the cross-link interference measurement resource, wherein the timing advance value corresponds to the selected timing advance value.

In a second aspect, alone or in combination with the first aspect, process 1000 includes receiving, from a network node, a cross-link interference measurement resource configuration that includes an indication of a cross-link interference measurement resource, and receiving, from the network node, after receiving the cross-link interference measurement resource configuration, an indication of the plurality of timing advance values and an element index associated with a timing advance value of the plurality of timing advance values, wherein selecting the timing advance value of the plurality of timing advance values comprises selecting the timing advance value that corresponds to the element index.

In a third aspect, alone or in combination with one or more of the first and second aspects, process 1000 includes receiving, from a network node, a cross-link interference measurement resource configuration that includes a relative timing indication for a cross-link interference measurement resource associated with the cross-link interference measurement resource configuration, wherein selecting the timing advance value comprises selecting the timing advance value based at least in part on the relative timing indication.

In a fourth aspect, alone or in combination with one or more of the first through third aspects, the relative timing indication is relative to a downlink timing of a serving cell associated with the UE or an uplink timing of the serving cell associated with the UE, wherein the UE is configured with the plurality of timing advance groups, and wherein the relative timing indication is relative to a timing advance group of the plurality of timing advance groups.

In a fifth aspect, alone or in combination with one or more of the first through fourth aspects, the UE is configured with the plurality of timing advance groups, wherein each timing advance value of the plurality of timing advance values is associated with transmission by the UE to a respective network node of a plurality of network nodes, and wherein measuring the cross-link interference comprises measuring the cross-link interference using a cross-link interference measurement resource.

In a sixth aspect, alone or in combination with one or more of the first through fifth aspects, a timing advance value of the plurality of timing advance values is associated with a transmission configuration indication state or a spatial relation, and wherein the transmission configuration indication state or the spatial relation is associated with the cross-link interference measurement resource.

In a seventh aspect, alone or in combination with one or more of the first through sixth aspects, a timing advance value of the plurality of timing advance values is associated with a control resource set pool index, and wherein the control resource set pool index is associated with the cross-link interference measurement resource.

In an eighth aspect, alone or in combination with one or more of the first through seventh aspects, a timing advance value of the plurality of timing advance values is associated with a synchronization signal block group, and wherein the synchronization signal block group is associated with the cross-link interference measurement resource.

In a ninth aspect, alone or in combination with one or more of the first through eighth aspects, a timing advance value of the plurality of timing advance values is associated with a timing advance value group identifier, and wherein the timing advance value group identifier is associated with the cross-link interference measurement resource.

In a tenth aspect, alone or in combination with one or more of the first through ninth aspects, process 1000 includes obtaining radio resource control configuration information that includes the timing advance value group identifier associated with the cross-link interference measurement resource.

In an eleventh aspect, alone or in combination with one or more of the first through tenth aspects, measuring the cross-link interference comprises measuring at least one of a cross-link interference reference signal received power or a cross-link interference reference signal strength indicator.

In a twelfth aspect, alone or in combination with one or more of the first through eleventh aspects, measuring the cross-link interference comprises measuring a reference signal received power and a reference signal strength indicator using the selected timing advance value.

In a thirteenth aspect, alone or in combination with one or more of the first through twelfth aspects, measuring the cross-link interference comprises measuring a reference signal received power using the selected timing advance value.

In a fourteenth aspect, alone or in combination with one or more of the first through thirteenth aspects, measuring the cross-link interference comprises measuring a reference signal strength indicator using the selected timing advance value.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with measuring cross-link interference.

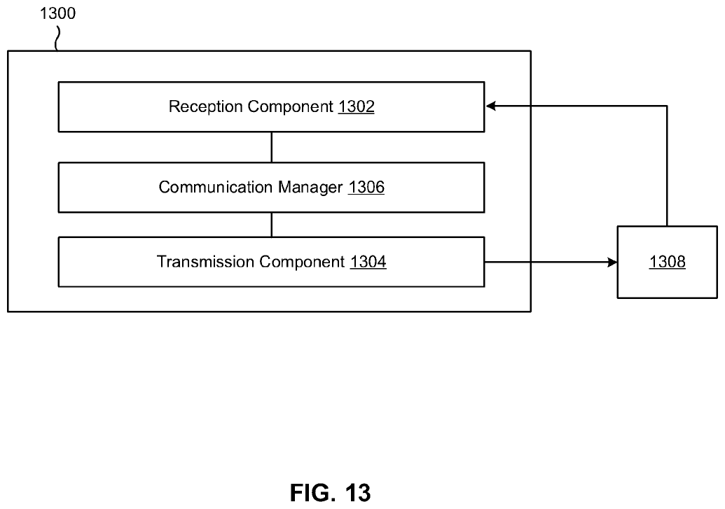

As shown in FIG. 11, in some aspects, process 1100 may include transmitting a cross-link interference measurement resource configuration that includes one or more cross-link interference measurement resources (block 1110). For example, the network node (e.g., using transmission component 1304 and/or communication manager 1306, depicted in FIG. 13) may transmit a cross-link interference measurement resource configuration that includes one or more cross-link interference measurement resources, as described above.

As further shown in FIG. 11, in some aspects, process 1100 may include receiving a transmission that is based at least in part on a cross-link interference measurement, the cross-link interference measurement being associated with a cross-link interference measurement resource of the one or more cross-link interference measurement resources and being based at least in part on a timing advance value of a plurality of timing advance values associated, respectively, with a plurality of timing advance groups (block 1120). For example, the network node (e.g., using reception component 1302 and/or communication manager 1306, depicted in FIG. 13) may receive a transmission that is based at least in part on a cross-link interference measurement, the cross-link interference measurement being associated with a cross-link interference measurement resource of the one or more cross-link interference measurement resources and being based at least in part on a timing advance value of a plurality of timing advance values associated, respectively, with a plurality of timing advance groups, as described above.

Process 1100 may include additional aspects, such as any single aspect or any combination of aspects described below and/or in connection with one or more other processes described elsewhere herein.

In a first aspect, process 1100 includes transmitting, after transmitting the cross-link interference measurement resource configuration, an indication of a timing advance value, of the plurality of timing advance values, to be used for the cross-link interference measurement.

In a second aspect, alone or in combination with the first aspect, process 1100 includes transmitting, after transmitting the cross-link interference measurement resource configuration, an indication of the plurality of timing advance values and an element index associated with the timing advance value.

In a third aspect, alone or in combination with one or more of the first and second aspects, transmitting the cross-link interference measurement resource configuration comprises transmitting a cross-link interference measurement resource configuration that includes a relative timing indication for the cross-link interference measurement resource.

In a fourth aspect, alone or in combination with one or more of the first through third aspects, the timing advance value of the plurality of timing advance values is associated with a transmission configuration indication state or a spatial relation, and wherein the transmission configuration indication state or the spatial relation is associated with the cross-link interference measurement resource.

In a fifth aspect, alone or in combination with one or more of the first through fourth aspects, the timing advance value of the plurality of timing advance values is associated with a control resource set pool index, and wherein the control resource set pool index is associated with the cross-link interference measurement resource.

In a sixth aspect, alone or in combination with one or more of the first through fifth aspects, the timing advance value of the plurality of timing advance values is associated with a synchronization signal block group, and wherein the synchronization signal block group is associated with the cross-link interference measurement resource.

In a seventh aspect, alone or in combination with one or more of the first through sixth aspects, the timing advance value of the plurality of timing advance values is associated with a timing advance value group identifier, and wherein the timing advance value group identifier is associated with the cross-link interference measurement resource.

In an eighth aspect, alone or in combination with one or more of the first through seventh aspects, process 1100 includes transmitting radio resource control configuration information that includes the timing advance value group identifier associated with the cross-link interference measurement resource.

In a ninth aspect, alone or in combination with one or more of the first through eighth aspects, the one or more cross-link interference measurement resources include a cross-link interference reference signal received power resource and a cross-link interference reference signal strength indicator resource.

In a tenth aspect, alone or in combination with one or more of the first through ninth aspects, the one or more cross-link interference measurement resources include a cross-link interference reference signal received power resource or a cross-link interference reference signal strength indicator resource.

In an eleventh aspect, alone or in combination with one or more of the first through tenth aspects, transmitting the cross-link interference measurement resource configuration comprises transmitting a first cross-link interference measurement resource configuration that includes a cross-link interference reference signal received power resource and a second cross-link interference measurement resource configuration that includes a cross-link interference reference signal strength indicator resource.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIG. 9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive cross-link interference associated with a transmission by another UE, at least one of the UE or the other UE being configured with a plurality of timing advance groups associated, respectively, with a plurality of timing advance values. The communication manager 1206 may select a timing advance value of the plurality of timing advance values. The communication manager 1206 may measure the cross-link interference using the selected timing advance value.

The reception component 1202 may receive, from a network node, a cross-link interference measurement resource configuration that includes an indication of a cross-link interference measurement resource. The reception component 1202 may receive, from the network node, after receiving the cross-link interference measurement resource configuration, an indication of a timing advance value to be used for the cross-link interference measurement resource, wherein the timing advance value corresponds to the selected timing advance value. The reception component 1202 may receive, from a network node, a cross-link interference measurement resource configuration that includes an indication of a cross-link interference measurement resource. The reception component 1202 may receive, from the network node, after receiving the cross-link interference measurement resource configuration, an indication of the plurality of timing advance values and an element index associated with a timing advance value of the plurality of timing advance values, wherein selecting the timing advance value of the plurality of timing advance values comprises selecting the timing advance value that corresponds to the element index. The reception component 1202 may receive, from a network node, a cross-link interference measurement resource configuration that includes a relative timing indication for a cross-link interference measurement resource associated with the cross-link interference measurement resource configuration, wherein selecting the timing advance value comprises selecting the timing advance value based at least in part on the relative timing indication. The reception component 1202 may obtain radio resource control configuration information that includes the timing advance value group identifier associated with the cross-link interference measurement resource.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIG. 9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit a cross-link interference measurement resource configuration that includes one or more cross-link interference measurement resources. The reception component 1302 may receive a transmission that is based at least in part on a cross-link interference measurement, the cross-link interference measurement being associated with a cross-link interference measurement resource of the one or more cross-link interference measurement resources and being based at least in part on a timing advance value of a plurality of timing advance values associated, respectively, with a plurality of timing advance groups.

The transmission component 1304 may transmit, after transmitting the cross-link interference measurement resource configuration, an indication of a timing advance value, of the plurality of timing advance values, to be used for the cross-link interference measurement. The transmission component 1304 may transmit, after transmitting the cross-link interference measurement resource configuration, an indication of the plurality of timing advance values and an element index associated with the timing advance value. The transmission component 1304 may transmit radio resource control configuration information that includes the timing advance value group identifier associated with the cross-link interference measurement resource.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving cross-link interference associated with a transmission by another UE, at least one of the UE or the other UE being configured with a plurality of timing advance groups associated, respectively, with a plurality of timing advance values; selecting a timing advance value of the plurality of timing advance values; and measuring the cross-link interference using the selected timing advance value.

Aspect 2: The method of Aspect 1, further comprising: receiving, from a network node, a cross-link interference measurement resource configuration that includes an indication of a cross-link interference measurement resource; and receiving, from the network node, after receiving the cross-link interference measurement resource configuration, an indication of a timing advance value to be used for the cross-link interference measurement resource, wherein the timing advance value corresponds to the selected timing advance value.

Aspect 3: The method of any of Aspects 1-2, further comprising: receiving, from a network node, a cross-link interference measurement resource configuration that includes an indication of a cross-link interference measurement resource; and receiving, from the network node, after receiving the cross-link interference measurement resource configuration, an indication of the plurality of timing advance values and an element index associated with a timing advance value of the plurality of timing advance values, wherein selecting the timing advance value of the plurality of timing advance values comprises selecting the timing advance value that corresponds to the element index.

Aspect 4: The method of any of Aspects 1-3, further comprising receiving, from a network node, a cross-link interference measurement resource configuration that includes a relative timing indication for a cross-link interference measurement resource associated with the cross-link interference measurement resource configuration, wherein selecting the timing advance value comprises selecting the timing advance value based at least in part on the relative timing indication.

Aspect 5: The method of Aspect 4, wherein the relative timing indication is relative to a downlink timing of a serving cell associated with the UE or an uplink timing of the serving cell associated with the UE, wherein the UE is configured with the plurality of timing advance groups, and wherein the relative timing indication is relative to a timing advance group of the plurality of timing advance groups.

Aspect 6: The method of any of Aspects 1-5, wherein the UE is configured with the plurality of timing advance groups, wherein each timing advance value of the plurality of timing advance values is associated with transmission by the UE to a respective network node of a plurality of network nodes, and wherein measuring the cross-link interference comprises measuring the cross-link interference using a cross-link interference measurement resource.

Aspect 7: The method of Aspect 6, wherein a timing advance value of the plurality of timing advance values is associated with a transmission configuration indication state or a spatial relation, and wherein the transmission configuration indication state or the spatial relation is associated with the cross-link interference measurement resource.

Aspect 8: The method of Aspect 6, wherein a timing advance value of the plurality of timing advance values is associated with a control resource set pool index, and wherein the control resource set pool index is associated with the cross-link interference measurement resource.

Aspect 9: The method of Aspect 6, wherein a timing advance value of the plurality of timing advance values is associated with a synchronization signal block group, and wherein the synchronization signal block group is associated with the cross-link interference measurement resource.

Aspect 10: The method of Aspect 6, wherein a timing advance value of the plurality of timing advance values is associated with a timing advance value group identifier, and wherein the timing advance value group identifier is associated with the cross-link interference measurement resource.

Aspect 11: The method of Aspect 10, further comprising obtaining radio resource control configuration information that includes the timing advance value group identifier associated with the cross-link interference measurement resource.

Aspect 12: The method of any of Aspects 1-11, wherein measuring the cross-link interference comprises measuring at least one of a cross-link interference reference signal received power or a cross-link interference reference signal strength indicator.

Aspect 13: The method of Aspect 12, wherein measuring the cross-link interference comprises measuring a reference signal received power and a reference signal strength indicator using the selected timing advance value.

Aspect 14: The method of Aspect 12, wherein measuring the cross-link interference comprises measuring a reference signal received power using the selected timing advance value.

Aspect 15: The method of Aspect 12, wherein measuring the cross-link interference comprises measuring a reference signal strength indicator using the selected timing advance value.

Aspect 16: A method of wireless communication performed by a network node, comprising: transmitting a cross-link interference measurement resource configuration that includes one or more cross-link interference measurement resources; and receiving a transmission that is based at least in part on a cross-link interference measurement, the cross-link interference measurement being associated with a cross-link interference measurement resource of the one or more cross-link interference measurement resources and being based at least in part on a timing advance value of a plurality of timing advance values associated, respectively, with a plurality of timing advance groups.

Aspect 17: The method of Aspect 16, further comprising transmitting, after transmitting the cross-link interference measurement resource configuration, an indication of a timing advance value, of the plurality of timing advance values, to be used for the cross-link interference measurement.

Aspect 18: The method of any of Aspects 16-17, further comprising transmitting, after transmitting the cross-link interference measurement resource configuration, an indication of the plurality of timing advance values and an element index associated with the timing advance value.

Aspect 19: The method of any of Aspects 16-18, wherein transmitting the cross-link interference measurement resource configuration comprises transmitting a cross-link interference measurement resource configuration that includes a relative timing indication for the cross-link interference measurement resource.

Aspect 20: The method of any of Aspects 16-19, wherein the timing advance value of the plurality of timing advance values is associated with a transmission configuration indication state or a spatial relation, and wherein the transmission configuration indication state or the spatial relation is associated with the cross-link interference measurement resource.

Aspect 21: The method of any of Aspects 16-20, wherein the timing advance value of the plurality of timing advance values is associated with a control resource set pool index, and wherein the control resource set pool index is associated with the cross-link interference measurement resource.

Aspect 22: The method of any of Aspects 16-21, wherein the timing advance value of the plurality of timing advance values is associated with a synchronization signal block group, and wherein the synchronization signal block group is associated with the cross-link interference measurement resource.

Aspect 23: The method of any of Aspects 16-22, wherein the timing advance value of the plurality of timing advance values is associated with a timing advance value group identifier, and wherein the timing advance value group identifier is associated with the cross-link interference measurement resource.

Aspect 24: The method of Aspect 23, further comprising transmitting radio resource control configuration information that includes the timing advance value group identifier associated with the cross-link interference measurement resource.

Aspect 25: The method of any of Aspects 16-24, wherein the one or more cross-link interference measurement resources include a cross-link interference reference signal received power resource and a cross-link interference reference signal strength indicator resource.

Aspect 26: The method of any of Aspects 16-25, wherein the one or more cross-link interference measurement resources include a cross-link interference reference signal received power resource or a cross-link interference reference signal strength indicator resource.

Aspect 27: The method of any of Aspects 16-26, wherein transmitting the cross-link interference measurement resource configuration comprises transmitting a first cross-link interference measurement resource configuration that includes a cross-link interference reference signal received power resource and a second cross-link interference measurement resource configuration that includes a cross-link interference reference signal strength indicator resource.

Aspect 28: An apparatus for wireless communication at a device, comprising a processor; memory coupled with the processor; and instructions stored in the memory and executable by the processor to cause the apparatus to perform the method of one or more of Aspects 1-27.

Aspect 29: A device for wireless communication, comprising a memory and one or more processors coupled to the memory, the one or more processors configured to perform the method of one or more of Aspects 1-27.

Aspect 30: An apparatus for wireless communication, comprising at least one means for performing the method of one or more of Aspects 1-27.

Aspect 31: A non-transitory computer-readable medium storing code for wireless communication, the code comprising instructions executable by a processor to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
receive cross-link interference associated with a transmission by another UE, at least one of the UE or the other UE being configured with a plurality of timing advance groups associated, respectively, with a plurality of timing advance values;
select a timing advance value of the plurality of timing advance values; and
measure the cross-link interference using the selected timing advance value.

2. The apparatus of claim 1, wherein the one or more processors are further configured to:
receive, from a network node, a cross-link interference measurement resource configuration that includes an indication of a cross-link interference measurement resource; and
receive, from the network node, after receiving the cross-link interference measurement resource configuration, an indication of a timing advance value to be used for the cross-link interference measurement resource, wherein the timing advance value corresponds to the selected timing advance value.

3. The apparatus of claim 1, wherein the one or more processors are further configured to:
receive, from a network node, a cross-link interference measurement resource configuration that includes an indication of a cross-link interference measurement resource; and
receive, from the network node, after receiving the cross-link interference measurement resource configuration, an indication of the plurality of timing advance values and an element index associated with a timing advance value of the plurality of timing advance values, wherein the one or more processors, to select the timing advance value of the plurality of timing advance values, are configured to select the timing advance value that corresponds to the element index.

4. The apparatus of claim 1, wherein the one or more processors are further configured to receive, from a network node, a cross-link interference measurement resource configuration that includes a relative timing indication for a cross-link interference measurement resource associated with the cross-link interference measurement resource configuration, wherein the one or more processors, to select the timing advance value of the plurality of timing advance values, are configured to select the timing advance value based at least in part on the relative timing indication.

5. The apparatus of claim 4, wherein the relative timing indication is relative to a downlink timing of a serving cell associated with the UE or an uplink timing of the serving cell associated with the UE, wherein the UE is configured with the plurality of timing advance groups, and wherein the relative timing indication is relative to a timing advance group of the plurality of timing advance groups.

6. The apparatus of claim 1, wherein the UE is configured with the plurality of timing advance groups, wherein each timing advance value of the plurality of timing advance values is associated with transmission by the UE to a respective network node of a plurality of network nodes, and wherein the one or more processors, to measure the cross-link interference, are configured to measure the cross-link interference using a cross-link interference measurement resource.

7. The apparatus of claim 6, wherein a timing advance value of the plurality of timing advance values is associated with a transmission configuration indication state or a spatial relation, and wherein the transmission configuration indication state or the spatial relation is associated with the cross-link interference measurement resource.

8. The apparatus of claim 6, wherein a timing advance value of the plurality of timing advance values is associated with a control resource set pool index, and wherein the control resource set pool index is associated with the cross-link interference measurement resource.

9. The apparatus of claim 6, wherein a timing advance value of the plurality of timing advance values is associated with a synchronization signal block group, and wherein the synchronization signal block group is associated with the cross-link interference measurement resource.

10. The apparatus of claim 6, wherein a timing advance value of the plurality of timing advance values is associated with a timing advance value group identifier, and wherein the timing advance value group identifier is associated with the cross-link interference measurement resource.

11. The apparatus of claim 10, wherein the one or more processors are further configured to obtain radio resource control configuration information that includes the timing advance value group identifier associated with the cross-link interference measurement resource.

12. The apparatus of claim 1, wherein the one or more processors, to measure the cross-link interference, are configured to measure at least one of a cross-link interference reference signal received power or a cross-link interference reference signal strength indicator.

13. The apparatus of claim 12, wherein the one or more processors, to measure the cross-link interference, are configured to measure a reference signal received power and a reference signal strength indicator using the selected timing advance value.

14. The apparatus of claim 12, wherein the one or more processors, to measure the cross-link interference, are configured to measure a reference signal received power using the selected timing advance value.

15. The apparatus of claim 12, wherein the one or more processors, to measure the cross-link interference, are configured to measure a reference signal strength indicator using the selected timing advance value.

16. An apparatus for wireless communication at a network node, comprising:
a memory; and
one or more processors, coupled to the memory, configured to:
transmit a cross-link interference measurement resource configuration that includes one or more cross-link interference measurement resources; and
receive a transmission that is based at least in part on a cross-link interference measurement, the cross-link interference measurement being associated with a cross-link interference measurement resource of the one or more cross-link interference measurement resources and being based at least in part on a timing advance value of a plurality of timing advance values associated, respectively, with a plurality of timing advance groups.

17-22. (canceled)

23. The apparatus of claim 16, wherein the timing advance value of the plurality of timing advance values is associated with a timing advance value group identifier, and wherein the timing advance value group identifier is associated with the cross-link interference measurement resource.

24. The apparatus of claim 23, wherein the one or more processors are further configured to transmit radio resource control configuration information that includes the timing advance value group identifier associated with the cross-link interference measurement resource.

25-27. (canceled)

28. A method of wireless communication performed by a user equipment (UE), comprising:
receiving cross-link interference associated with a transmission by another UE, at least one of the UE or the other UE being configured with a plurality of timing advance groups associated, respectively, with a plurality of timing advance values;
selecting a timing advance value of the plurality of timing advance values; and
measuring the cross-link interference using the selected timing advance value.

29. The method of claim 28, further comprising:
receiving, from a network node, a cross-link interference measurement resource configuration that includes an indication of a cross-link interference measurement resource; and
receiving, from the network node, after receiving the cross-link interference measurement resource configuration, an indication of a timing advance value to be used for the cross-link interference measurement resource, wherein the timing advance value corresponds to the selected timing advance value.

30. (canceled)
